(19) United States
(12) Patent Application Publication
(10) Pub. No.: US 2025/0103610 A1
(43) Pub. Date: Mar. 27, 2025

(54) DOCUMENT INTELLIGENCE INTEGRATION INTO INGESTION PIPELINE

(71) Applicant: Snowflake Inc., Bozeman, MT (US)

(72) Inventors: Abdullah Al Mahmood, Bothell, WA (US); Ganeshan Ramachandran lyer, Redmond, WA (US); Subramanian Muralidhar, Mercer Island, WA (US)

(21) Appl. No.: 18/472,849

(22) Filed: Sep. 22, 2023

(51) Int. Cl. G06F 16/25; G06F 16/215; G06F 16/2453

(52) U.S. Cl. CPC G06F 16/258; G06F 16/215; G06F 16/24542; G06F 16/256

(57) ABSTRACT

Techniques for ingestion of unstructured files into a target table stored in a network-based database system are described. The unstructured files may include formats not natively supported by a database system. An external service may be used to process the unstructured files. The database system may employ external calls to request the external service to process the unstructured files and provide the results in a specified response schema including metadata.

### TECHNICAL FIELD

The present disclosure generally relates to data systems, such as network-based database systems, and, more specifically, to data ingestion techniques for unstructured file formats.

### BACKGROUND

Data systems, such as database systems, may be provided through a cloud platform, which allows organizations and users to store, manage, and retrieve data from the cloud. A variety of techniques can be employed for uploading and storing data in a database or table in a cloud platform. Uploading techniques typically cannot account for different file formats, in particular unstructured file formats.

### BRIEF DESCRIPTION OF THE DRAWINGS

Various ones of the appended drawings merely illustrate example embodiments of the present disclosure and should not be considered as limiting its scope.

FIG. 1 illustrates an example computing environment with a cloud database system, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a simplified block diagram of a system for automated data ingestion, according to some example embodiments.

FIG. 5 is a schematic block diagram of a process of ingesting data into a database, according to some example embodiments.

FIG. 6 is a simplified block diagram of a system for automated data ingestion for unstructured files using an external service, according to some example embodiments.

FIG. 7 illustrates example portions of a query plan for a copy or ingestion command including unstructured files, according to some example embodiments.

FIG. 8A illustrates example portions of a query plan for a first step for a copy or ingestion command including unstructured files, according to some example embodiments.

FIG. 8B illustrates example portions of a query plan for a second step for a copy or ingestion command including unstructured files, according to some example embodiments.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Techniques for ingestion of unstructured files into a target table stored in a network-based database system are described. The unstructured files may include formats not natively supported by a database system. An external service may be used to process the unstructured files. The database system may employ external calls to request the external service to process the unstructured files and provide the results in a specified response schema including metadata. An external function rowset processor may be used to parse the results and generate statistics based on the received metadata. The parsed results may then be inserted into the target table.

These techniques provide technical advantages of allowing the network-based database system to handle and ingest unstructured formats into the system that would otherwise be unable to ingest. Moreover, the techniques using the external service allows the system to use robust features (e.g., error handling, deduplication, etc.,) of the ingestion components of the system to unstructured files. Users can have the ability to extract useful data from unstructured files by posing queries in natural language. As described in further detail below, the responses to these queries can be extracted directly from the unstructured files and loaded into a target table, enhancing the flexibility and utility of the network-based database system.

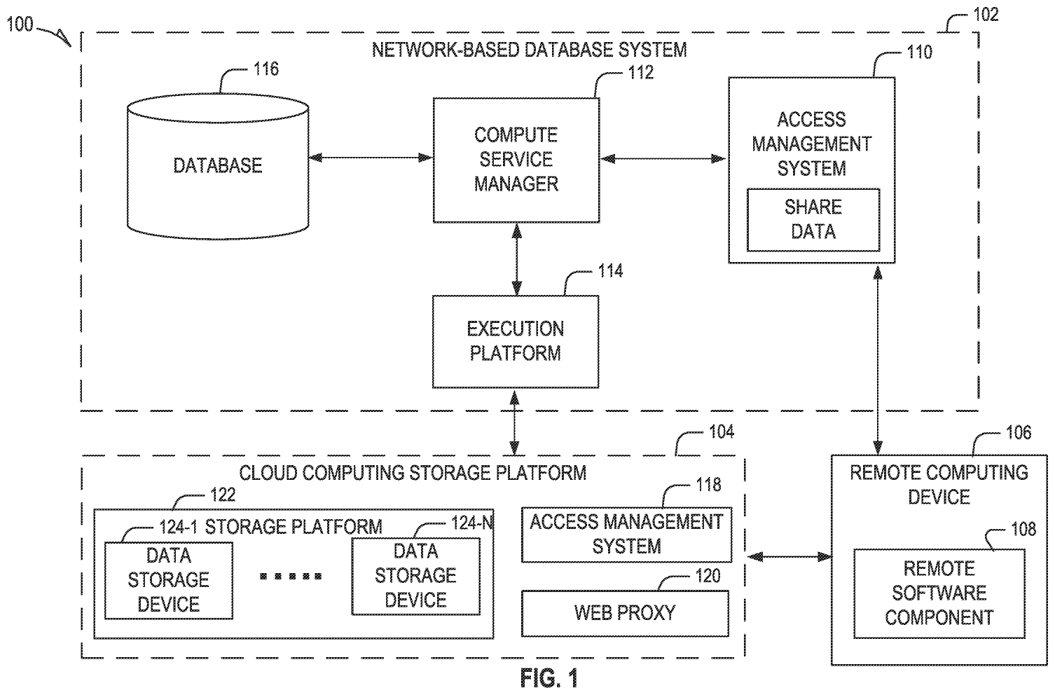

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform (XP) 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

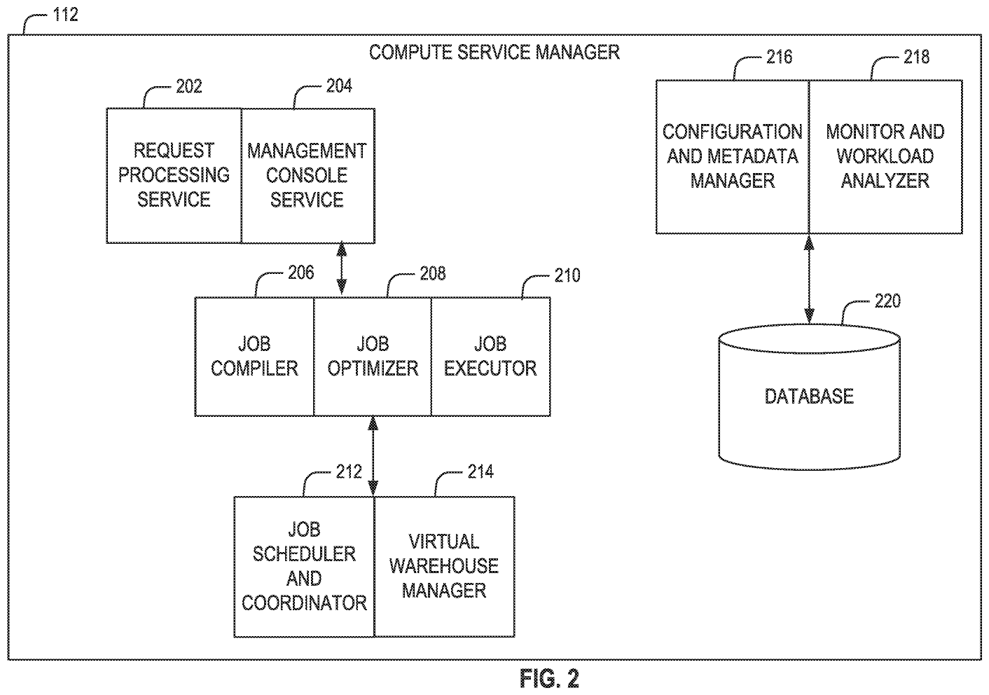

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represents any data storage device within the network-based database system 102. For example, data storage device 220 may represent caches in execution platform 114, storage devices in cloud computing storage platform 104, or any other storage device.

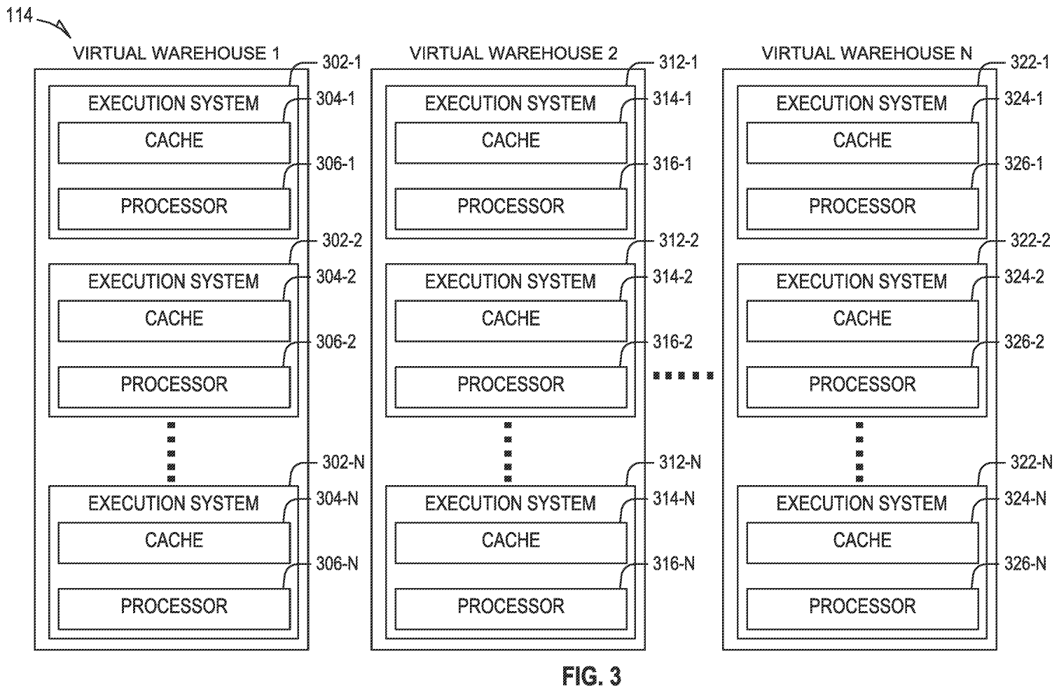

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

As mentioned above, data from a client storage can be uploaded to the data warehouse. Some techniques can use a “copy” command for this transfer. The “copy” command is typically manually performed or performed based on a set schedule (say, every 15 minutes). However, the use of such “copy” commands can add latency.

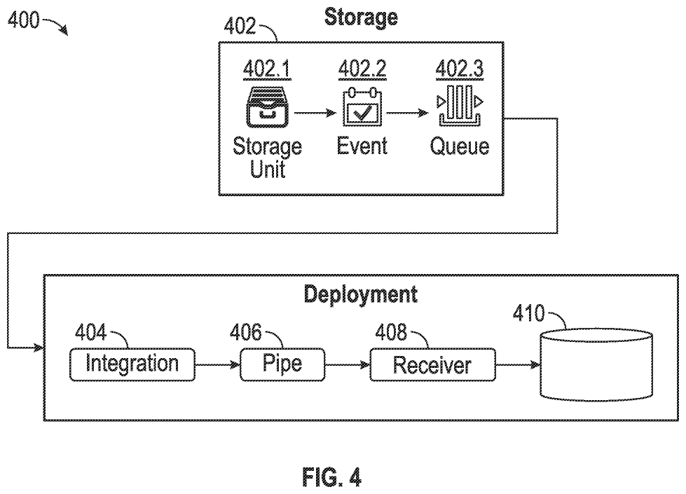

Consequently, latency can be improved by implementing auto-ingestion techniques, as described in further detail below. FIG. 4 is a simplified block diagram of system 400 for automated data ingestion, according to some example embodiments. The system may include a storage 402, which may be provided as cloud storage (e.g., Amazon S3 storage, Azure storage, GCP storage, etc.). The storage 402 may include client data to upload to the data warehouse.

The storage 402 may store files (or data) to be ingested into a database 410. In some embodiments, the storage 402 may include a storage unit 402.1, an event block 402.2, and a queue 402.3. The system may also include a deployment to ingest data in the database 410. A deployment may include multiple components such as a metadata store/DB, a front-end layer, a load balancing layer, a data warehouse, etc., as discussed above with respect to FIGS. 1-3. The deployments may be provided as public or private deployments. A public deployment may be implemented as a multi-tenant environment, where each tenant or account shares processing and/or storage resources. For example, in a public deployment, multiple accounts may share a metadata store, a front-end layer, a load balancing layer, a data warehouse, etc. A private deployment, on the other hand, may be implemented as a dedicated, isolated environment, where processing and/or storage resources may be dedicated.

The deployment may be communicatively coupled to the queue 402.3, and may include an integration 404, a pipe 406, and a receiver 408. Integration 404 may be configured to receive a notification when new data becomes available in queue 402.3. For example, the queue may include a pool of Simple Queue Service™ (SQS) queues as part of an Amazon Web Services™ S3 bucket. The pool of SQS queues may be provided to client accounts to add user files to a bucket. A notification may be automatically generated when one or more user files are added to a client account data bucket. A plurality of customer data buckets may be provided for each client account. The automatically generated notification may be received by the integration 404.

For example, the integration 404 may provide information relating to an occurrence of an event in the queue 402.3. Events may include creation of new data, update of old data, and deletion of old data. The integration 404 may also provide identification information for a resource associated with the event, e.g., the user file that has been created, updated, or deleted. The integration 404 may communicate with the queue 402.3 because the integration 404 may be provided with credentials for the queue 402.3, for example by an administrator and/or user. In an embodiment, the integration 404 may poll the queue 402.3 for notifications.

The integration 404 may deliver the notification to the pipe 406, which may be provided as a single pipe or multiple pipes. The pipe 406 may store information relating to what data and the location of the data for automatic data ingestion related to the queue 402.3.

The receiver 408 may perform the automated data ingestion, and then store the ingested data in the database 410. Data ingestion may be performed using the techniques described in U.S. patent application Ser. No. 16/201,854, entitled “Batch Data Ingestion in Database Systems,” filed on Nov. 27, 2018, which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

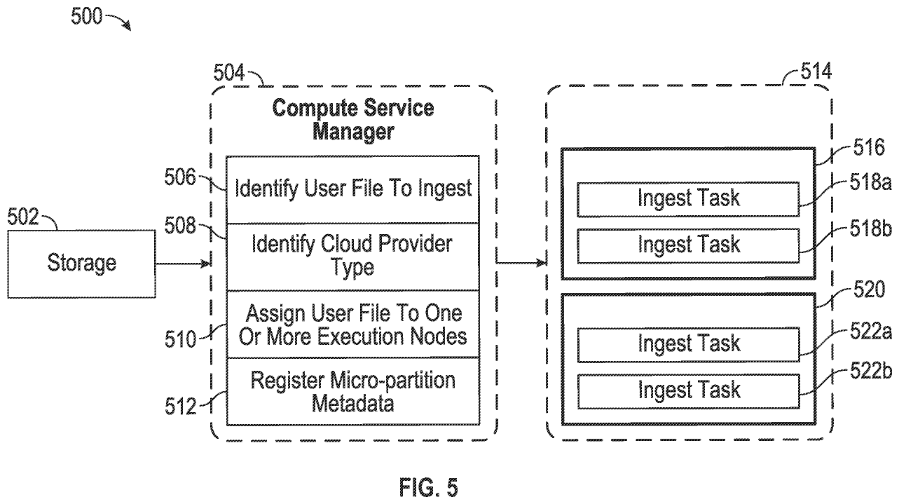

FIG. 5 is a schematic block diagram of a process 500 of ingesting data into a database, according to some example embodiments. The process 500 begins and a storage 502 sends an ingest request, such as a notification. The storage 502 may directly or indirectly communicate with the database system to send in the ingest request. In some embodiments, the ingest request is a notification provided by a third-party vendor storage account, or the ingest request may arise from a compute service manager polling a data lake associated with the client account to determine whether any user files have been added to the client account that have not yet been ingested into the database. The notification includes a list of files to insert into a table of the database. The files are persisted in a queue specific to the receiving table of the database.

The ingest request is received by a compute service manager 504. The compute service manager 504 identifies at step 506 a user file to ingest. At step 508, the compute service manager identifies a cloud provider type associated with the client account. At step 510, the compute service manager 504 may assign the user file to one or more execution nodes, based at least in part on the detected cloud provider type, and registers at step 512 micro-partition metadata associated with a database table after the file is ingested into a micro-partition of the database table. The compute service manager 504 provisions one or more execution nodes 516, 520 of an execution platform 514 to perform one or more tasks associated with ingesting the user file. Such ingest tasks 518a, 518b, 522a, 522b include, for example, cutting a file into one or more sections, generating a new micro-partition based on the user file, and/or inserting the new micro-partition in a table of the database.

The process 500 begins an ingest task that is executed by a warehouse. The ingest task may pull user files from the queue for a database table until it is told to stop doing so. The ingest task may periodically cut a new user file and add it to the database table. In one embodiment, the ingest process is “serverless” in that it is an integrated service provided by the database or compute service manager 504. That is, a user associated with the client account need not provision its own warehouse or a third-party warehouse in order to perform the ingestion process. For example, the database or database provided (e.g., via instances of the compute service manager 504) may maintain the ingest warehouse that then services one or more or all accounts/customers of the database provider.

In some embodiments, there may be more than one ingest task pulling from a queue for a given table, and this might be necessary to keep up with the rate of incoming data. In some embodiments, the ingest task may decide the time to cut a new file to increase the chances of getting an ideal sized file and avoid “odd sized” files that would result if the file size was lined up with one or more user files. This may come at the cost of added complexity as the track line number of the files consumed must be tracked.

Users may have files in unstructured file formats (e.g., files not natively supported) that may not be amenable to ingestion. For example, a data system may support ingestion of native formats, such csv, json, avro, parquet, orc, xml. However, users may have data in other unstructured file formats, such as images, doc, pdf, video, audio, etc., that are not typically supported by data systems. Some data systems may have workarounds for non-supported file formats such as using tasks that have INSERT statements to insert data in the custom file format into a table. However, this workaround suffers from issues. Tasks typically do not have overlapping executions so work will be queued until the previous execution is completed, which adds to latency. Scaling to large volume of continuous events cannot be performed. Also, this type of workaround cannot take advantage of features built into ingestion components of the data system, such as error handling, deduplication, and schema evolution.

Techniques for using external services to handle unstructured files with the ingestion components of a data system are described next. For example, external services with machine learning (ML) capabilities can be integrated with ingestion pipelines, as described above. Integration with external services can enable ingestion of data from unstructured files, while preserving the robust features provided by the data system, such as error handling, deduplication, and schema evolution.

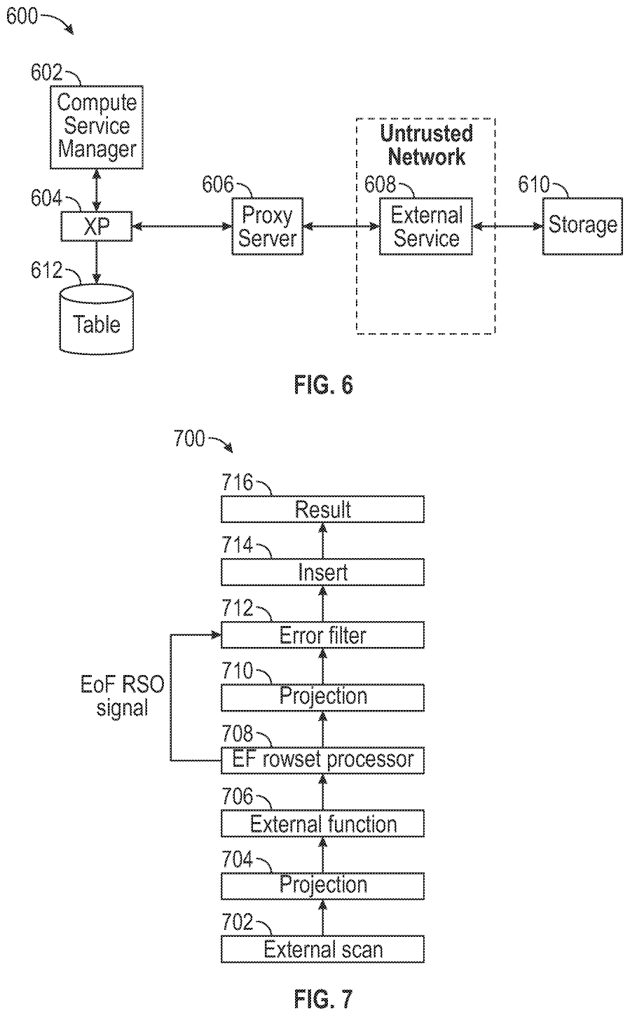

FIG. 6 is a simplified block diagram of system 600 for automated data ingestion for unstructured files using an external service, according to some example embodiments. The system includes a compute service manager 602. The compute service manager 602 may include the functionalities described above for compute service managers described herein (e.g., compute service manager 112, compute service manager 504). The compute service manager 602 may receive notifications of ingest requests from a plurality of accounts associated with the multi-tenant data system. The compute service manager 602 may assign ingest tasks to one or more execution platforms (XPs) 604 based on the ingest request notifications. The ingest requests may be for natively supported file formats and/or unstructured file formats, as described herein.

For unstructured file formats, the one or more XPs 604 may call an external function (e.g., external user-defined function) to process the unstructured files in an external service 608. In some example embodiments, the external function is a type of UDF of the database system; however, unlike other UDFs of the database system (e.g., an outbound serializer UDF, an inbound deserializer UDF, as discussed below), the external function does not contain its own code, and instead, the external function calls code that is stored and executed outside the database (e.g., on the external network service). The UDF can be provided as a user-defined table function (UDTF). In some embodiments, inside the database, the external function is stored as a database object that contains information that the database uses to call the external service. For example, the stored information includes a URL of the proxy service that relays information to and from the external service. In some example embodiments, the stored information is specified in a CREATE EXTERNAL FUNCTION command. In some embodiments, the database object that represents the external function is created in a specific database of the database system and has a specific schema. In some embodiments, the external function is called using dot notation to represent the fully-qualified name (e.g., “select my_DB.my_schema.my_extFunction(col1) from table1;”), which is a database function that calls code that is executed outside the database system (e.g., remotely, for processing on a third-party network service). The data of the external service may need to be translated from the data format of the database to the data format of the external service with which the database is in communication. The translation occurs in both directions. For example, to utilize an external service (e.g., sentiment detection, language translation, data analysis services) a query is received on the database system and the corresponding data of the query is translated from a first proprietary format used by the database to a second proprietary format used by the external service, and then sent to the network service for processing.

In some example embodiments, the external function is a UDF stored by the network-based database system, and interfaces with a serializer user-defined function in the network-based database system, which serializes the data from the data format of the network-based database system (e.g., proprietary JavaScript Object Notation (JSON) data format of the database) to the format of the external service 608 (e.g., a custom JSON format that is proprietary to the external service 608).

The data returned from the external service 608 is transformed using a deserializer user-defined function (e.g., an inbound UDF file) from the data format of the external service 608 to the data format of the network-based database system. In some example embodiments, the data that is to be processed by the UDFs and the external service 608 is stored in a storage platform, and then retrieved and stored in execution nodes for processing by the serializer user-defined function and the deserializer user-defined function.

In some example embodiments, the one or more XPs 604 of the network-based database system do not call the external service 608 directly, and instead call a proxy service 606 that is an API gateway service (e.g., Amazon API Gateway, Microsoft Azure API Management service) that sends and receives data directly from the external service 608. Further, in some example embodiments, the network-based database system utilizes an API integration database object, such as API Integrate Object that stores information (e.g., security information, credentials, addresses) that is used to work with the proxy service 606 and the external service 608.

In some example embodiments, the outbound serializer and inbound deserializer UDFs are written and stored as pairs, for use in processing data using a particular external service. For example, the serializer user-defined function and the deserializer user-defined function are written by a UDF developer and stored on the network-based database system for use in transforming data to and from the external service 608. In some example embodiments, the external function, serializer, and deserializer are generated on the network-based database system on a provider database account of a provider user (e.g., UDF developer), and the UDFs are shared with the consumer user for execution on the consumer database data using consumer-managed execution nodes (e.g., consumer account activated XP nodes that execute the external function UDF, serializer UDF, and deserializer UDF). Although a outbound serializer and inbound deserializer pair are discussed, as an example, in some example embodiments the database system implements an outbound serializer without an inbound deserializer (e.g., for one-directional outbound data), and further in some example embodiments, the database system implements an inbound deserializer without the outbound serializer (e.g., for one-directional inbound data).

In some example embodiments, the database system calls the serializer user-defined function and the deserializer user-defined function automatically, in response to the external function being called. For instance, the network-based database system calls the serializer user-defined function and passes the database formatted data from the storage platform into the serializer user-defined function. The transformed data output by the serializer user-defined function is then transmitted to the external service 608. The external service 608 then performs the requested processing and sends back the returned data that is still in the native format of the external service 608. Upon receiving the returned data, the network-based database system calls the deserializer user-defined function to convert the data back to the format that is native to the network-based database system (e.g., custom proprietary JSON format of the network-based database system, from comma separated value (CSV) format to a different CSV format, from JSON format to CSV format, from a text (.txt) format to a different text format). From the perspective of the user operating the client device, calling an external function with the serializer user-defined function or the deserializer user-defined function is the same as calling any other external function (e.g., the user specifies the external function in the query “SELECT” and the network-based database system implements the serializer user-defined function and the deserializer user-defined function automatically).

Although in FIG. 6 only a single external service and a single external function are illustrated, it is appreciated that a plurality of external services and a plurality of external functions and corresponding serializer/deserializer UDF pairs can be generated and managed by the external function access system architecture to enable the database to efficiently interface with many different external network services.

The external service 608 may be provided in a separate cloud system, such as a virtual private cloud, from the network-based database system, and thus may be considered “untrusted.” Based on the received external function call, the external service 608 may retrieve unstructured files to be ingested from the designated stage location 610. The stage location 610 may be a cloud storage location (e.g., S3 bucket). The stage location 610 may be internal or external to the external service 608.

The external service 608 may include a machine-learning (ML) model (e.g., Text-Image-Layout-Transformer (TILT) model) to extract features from unstructured files. In some example embodiments, the ML model may be trained to extract specified data or features from unstructured files, such as pdf, images, passports, etc. As used herein, a ML model can comprise a large-language model (LLM).

The external service 608 may transmit results of the external function to the one or more XPs 604. The results may be provided in a specified response schema. The response schema may include the results as a data object and metadata used for various purposes, such as error handling, deduplication, file and row mapping, file-based load history, etc. The following is an example of a response “documentMetadata” containing the file metadata and extracted data, such as member_id, member_name, and provider:

```
“data” : {
  ″_{——}documentMetadata″: {
  ″ocrScore″: 0.809
  },
  ″member_id″: [
  {
    ″children″: { },
    ″index″: 0,
    ″score″: 0.998,
    ″value″: ″00000999999999″
  }
  ],
  ″member_name″: [
  {
    ″children″: { },
    ″index″: 0,
    ″score″: 0.998,
    ″value″: ″John Doe″
  }
  ],
  ″provider″: [
  {
    ″children″: { },
    ″index″: 0,
    ″score″: 0.813,
    ″value″: ″MOLINA″
  }
  ]
}
}
```

The children field may indicate whether the value is a child of another node. The score field may indicate the OCR confidence value, for example. Index field may include the index value, if any.

The results may include a variant output or a schematized output from the UDF. For example, the results may be provided in a single variant column, where a single scanner can be used to load into multiple tables of different schemas. In some embodiments, the results may be provided in schematized columns, where depending on the target table schema different custom scanner/UDF may be used to load data from the same source. In a schematized column example, error information may be returned in a first column followed by N number of data columns of corresponding data types.

The one or more XPs 604 may then insert the results in a table 612. The results may be committed and registered in the table 612. Hence, user queries may be executed using the results from the external call stored in the table 612.

The process of utilizing an external service to perform a portion of copy commands, auto-ingestion, or other operations may be represented by way of query processing. A query may be received from a computing device (e.g., remote computing device 106) by a compute service manager (e.g., compute service manager 112, compute service manager 602). The query may be related to copy, auto-ingestion, or other operations associated with at least some unstructured files.

An example of a query for a copy command can be represented as:

copy into <target_table>
from <@source_stage>
FILE_PROCESSOR = (SCANNER = <EXT_FUNCT_NAME>
SCANNER_OPTIONS = <key_value_pairs>)

The scanner can be a document intelligence function, such as a function to extract features from a document (e.g., document_extract_features function). The scanner options can include key value pairs. A set of properties can be based on the external function. In the document_extract_features function example, the predefined set of properties can include model name, model version, and feature list. Consequently, the scanner options for the document_extract_features function example can include model_name=<model_name> model_version=<model_version> or feature_list=<key_value_pairs>.

For ingestion, an example of a query can be represented as:

create or replace pipe <pipe_name> as
copy into <target_table> from <@source_stage>
FILE_PROCESSOR = (SCANNER = <EXT_FUNCT_NAME>
SCANNER_OPTIONS = <key_value_pairs>)

Other pipe specific options, such as auto ingestion, error integration, etc., as described herein, can be included,

The compute service manager may generate a query plan to execute the query. The compute service manager may assign different tasks to one or more XPs based on the query plan for execution, as described herein.

FIG. 7 illustrates example portions of a query plan 700 for a copy or ingestion command including unstructured files, according to some example embodiments. The query plan 700 may begin with an external scan operation 702 files in the stage location. A projection operation 704 may be applied to the scanned data. The projection operation 704 may apply SQL functions or perform expression evaluation on the scanned data.

An external function 706 may be called to handle the unstructured files in the stage location. The external function 706 may call an external service to process unstructured files from the stage location, as described above. For example, the external function 706 may be called by one or more XPs. For example, the external service may include a ML model trained to extract specified data or features from the unstructured files based on the external call.

The external service may transmit the results back to network-based database system (e.g., XPs) in a specified response schema, as described above. The response schema may include the result data along with metadata, which the network-based database system can use for procedures such as file deduplication, load history, file-based statistics, etc. For example, for a respective file, the metadata can include an external file name, number of rows parsed, number of errors seen, error message (if needed), and information about the error message (if needed).

An external function (EF) rowset processor 708 may receive the incoming results from the external service and parse the results. The EF rowset processor 708 may extract the relevant result data from the incoming results. For example, the EF rowset processor 708 can extract the value corresponding to a certain column in the target table based on the column name. Also, the EF rowset processor 708 may also use the metadata in the incoming response results for various operations. For example, EF rowset processor 708 may perform error handling and deduplication based on the metadata in the response schema. The EF rowset processor 708 may also generate load history, file-based statistics, etc., based on the metadata in the response schema.

Another projection operation 710 may be provided on top of the EF rowset processor 708 if the query involves explicit transformation in addition to the response from the external function. In these cases, the transform functions may be applied by the projection operation 710. An error filter 712 may be provided to perform error filtering for the transformed data from projection operation 710. An insert operation 714 may insert the data into the target table. A result operation 716 may generate a result of the query.

In query plan 700, the same set of one or more XPs calling the external function are configured to receive the results from the external service to perform the subsequent operations. Hence, the set of one or more XPs wait for the results after calling the external function. This technique of using the same set of one more XPs can lead to inefficient use of resources when the external function is taking time to execute. During the external function execution time, the set of one or more XPs can be stalled or on hold.

The query plan can be modified into a two-step pipeline with each step being performed by different sets of XPs. In a first step, a first set of one or more XPs can interact with an external service to generate intermediate results in a semi-structured format being stored in a cloud storage location (e.g., published via S3 files). In a second step, a second set of one or more XPs can operate similar to a traditional pipe and ingest the intermediate results into the target table.

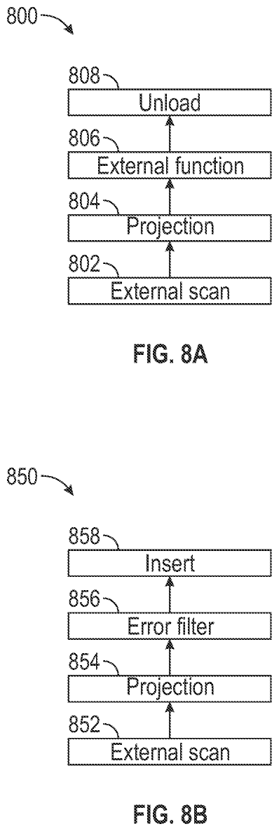

FIG. 8A illustrates example portions of a query plan 800 for a first step for a copy or ingestion command including unstructured files, according to some example embodiments. The query plan 800 may begin with an external scan operation 802 of files in the stage location. A projection operation 804 may be applied to the scanned data. The projection operation 804 may apply SQL functions or perform expression evaluation on the scanned data.

An external function 806 may be called to handle the unstructured files in the stage location. The external function 806 may call an external service to process unstructured files from the stage location, as described above. For example, the external function 806 may be called by a first set of one or more XPs. Notably, the first set of XPs may be released by the network-based data system after placing the external call so that the first set of XPs may be used for other tasks by the network-based data system.

For example, the external service may include a ML model trained to extract specified data or features from the unstructured files based on the external call. At unload operation 808, the external service may store intermediate results in a semi structured format (e.g., parquet/json) in a storage location (e.g., S3 bucket). The intermediate results may be provided in a specified response schema, as described above. The response schema may include the result data in the semi structured format along with metadata, which can be used for procedures such as file deduplication, load history, file-based statistics, etc. For example, for a respective file, the metadata can include an external file name, number of rows parsed, number of errors seen, error message (if needed), and information about the error message (if needed).

When the intermediate results are unloaded in the intermediate stage, a second pipe is notified to ingest the intermediate results into the target table. FIG. 8B illustrates example portions of a query plan 850 for a second step for a copy or ingestion command including unstructured files, according to some example embodiments. After the notification of the intermediate results being unloaded in the intermediate stage is received, a second set of one or more XPs may be assigned to perform ingest tasks associated with the intermediate results in the semi structured format, as described herein.

An external scan operation 852 may be performed on the intermediate results. A projection operation 854 may be provided on top of the externa scan operation if the query involves explicit transformation in addition to the response from the external function. In these cases, the transform functions may be applied by the projection operation 854. An error filter 856 may be provided to perform error filtering for the transformed data from projection operation 854. An insert operation 858 may insert the data into the target table.

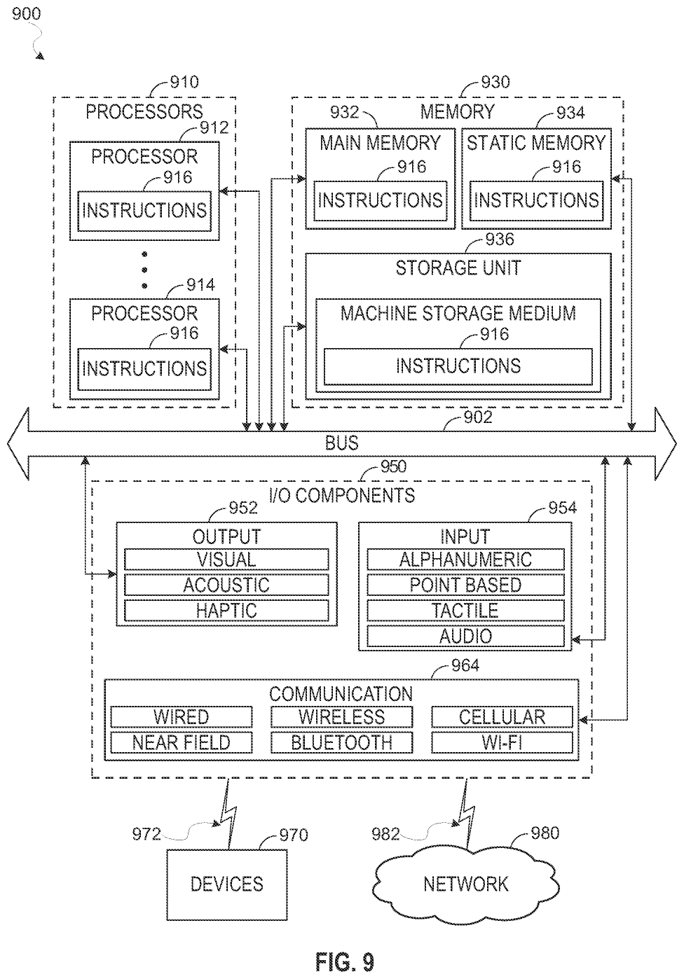

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute any one or more operations of any one or more of the methods described herein. As another example, the instructions 916 may cause the machine 900 to implement portions of the data flows described herein. In this way, the instructions 916 transform a general, non-programmed machine into a particular machine 900 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 includes processors 910, memory 930, and input/output (I/O) components 950 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, and other communication components to provide communication via other modalities. The devices 970 may be another machine or any of a wide variety of peripheral devices (e.g., a peripheral device coupled via a universal serial bus (USB)). For example, as noted above, the machine 900 may correspond to any one of the remote computing device 106, the access management system 118, the compute service manager 112, the execution platform 114, the access management system 110, the Web proxy 120, and the devices 970 may include any other of these systems and devices.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving, by at least one hardware processor in a network-based database system, a request to copy at least one file from a stage location into a target table stored in the network-based database system, the at least one file including at least one unstructured file not natively supported by the network-based database system; performing, by the network-based database system, an external call to an external service to process the at least one unstructured file, the external call including the stage location; receiving, by the network-based database system, results of processing the at least one unstructured file by the external service, the results being provided in a specified responses schema including metadata; extracting relevant data from the results; and inserting the relevant data into the target table.

Example 2. The method of example 1, further comprising: performing error handling on the results based on the metadata included in the specified response schema.

Example 3. The method of any of examples 1-2, further comprising: performing deduplication on the results based on the metadata included in the specified response schema.

Example 4. The method of any of examples 1-3, wherein extracting relevant data includes: extracting from the results a value corresponding to a specified column in the target table based on a column name.

Example 5. The method of any of examples 1-4, wherein a set of one or more execution nodes in the network-based database system perform the external call and the set of one or more execution nodes receive the results.

Example 6. The method of any of examples 1-5, wherein a first set of one or more execution nodes in the network-based database system perform the external call, wherein the first set of one or more execution nodes are released after performing the external call, and wherein a second set of one or more execution nodes generate the results.

Example 7. The method of any of examples 1-6, further comprising: retrieving intermediate results in semi-structured format from a storage device; and scanning the intermediate results to generate the results.

Example 8. A system comprising: one or more processors of a machine; and a memory storing instructions that, when executed by the one or more processors, cause the machine to perform operations implementing any one of example methods 1 to 7.

Example 9. A machine-readable storage device embodying instructions that, when executed by a machine, cause the machine to perform operations implementing any one of example methods 1 to 7.

What is claimed is:

1. A method comprising:
receiving, by at least one hardware processor in a network-based database system, a request to copy at least one file from a stage location into a target table stored in the network-based database system, the at least one file including at least one unstructured file not natively supported by the network-based database system;
performing, by the network-based database system, an external call to an external service to process the at least one unstructured file, the external call including the stage location;
receiving, by the network-based database system, results of processing the at least one unstructured file by the external service, the results being provided in a specified responses schema including metadata;
extracting relevant data from the results; and
inserting the relevant data into the target table.

2. The method of claim 1, further comprising:
performing error handling on the results based on the metadata included in the specified response schema.

3. The method of claim 1, further comprising:
performing deduplication on the results based on the metadata included in the specified response schema.

4. The method of claim 1, wherein extracting relevant data includes:
extracting from the results a value corresponding to a specified column in the target table based on a column name.

5. The method of claim 1, wherein a set of one or more execution nodes in the network-based database system perform the external call and the set of one or more execution nodes receive the results.

6. The method of claim 1, wherein a first set of one or more execution nodes in the network-based database system perform the external call, wherein the first set of one or more execution nodes are released after performing the external call, and wherein a second set of one or more execution nodes generate the results.

7. The method of claim 6, further comprising:
retrieving intermediate results in semi-structured format from a storage device; and
scanning the intermediate results to generate the results.

8. A machine-storage medium embodying instructions that, when executed by a machine, cause the machine to perform operations comprising:
receiving, by at least one hardware processor in a network-based database system, a request to copy at least one file from a stage location into a target table stored in the network-based database system, the at least one file including at least one unstructured file not natively supported by the network-based database system;
performing, by the network-based database system, an external call to an external service to process the at least one unstructured file, the external call including the stage location;
receiving, by the network-based database system, results of processing the at least one unstructured file by the external service, the results being provided in a specified responses schema including metadata;
extracting relevant data from the results; and
inserting the relevant data into the target table.

9. The machine-storage medium of claim 8, further comprising:
performing error handling on the results based on the metadata included in the specified response schema.

10. The machine-storage medium of claim 8, further comprising:
performing deduplication on the results based on the metadata included in the specified response schema.

11. The machine-storage medium of claim 8, wherein extracting relevant data includes:
extracting from the results a value corresponding to a specified column in the target table based on a column name.

12. The machine-storage medium of claim 8, wherein a set of one or more execution nodes in the network-based database system perform the external call and the set of one or more execution nodes receive the results.

13. The machine-storage medium of claim 8, wherein a first set of one or more execution nodes in the network-based database system perform the external call, wherein the first set of one or more execution nodes are released after performing the external call, and wherein a second set of one or more execution nodes generate the results.

14. The machine-storage medium of claim 13, further comprising:
retrieving intermediate results in semi-structured format from a storage device; and
scanning the intermediate results to generate the results.

15. A system comprising:
at least one hardware processor; and
at least one memory storing instructions that, when executed by the at least one hardware processor, cause the at least one hardware processor to perform operations comprising:
receiving, by at least one hardware processor in a network-based database system, a request to copy at least one file from a stage location into a target table stored in the network-based database system, the at least one file including at least one unstructured file not natively supported by the network-based database system;
performing, by the network-based database system, an external call to an external service to process the at least one unstructured file, the external call including the stage location;
receiving, by the network-based database system, results of processing the at least one unstructured file by the external service, the results being provided in a specified responses schema including metadata;
extracting relevant data from the results; and
inserting the relevant data into the target table.

16. The system of claim 15, the operations further comprising:
performing error handling on the results based on the metadata included in the specified response schema.

17. The system of claim 15, the operations further comprising:
performing deduplication on the results based on the metadata included in the specified response schema.

18. The system of claim 15, wherein extracting relevant data includes:
extracting from the results a value corresponding to a specified column in the target table based on a column name.

19. The system of claim 15, wherein a set of one or more execution nodes in the network-based database system perform the external call and the set of one or more execution nodes receive the results.

20. The system of claim 15, wherein a first set of one or more execution nodes in the network-based database system perform the external call, wherein the first set of one or more execution nodes are released after performing the external call, and wherein a second set of one or more execution nodes generate the results.

21. The system of claim 20, the operations further comprising:
retrieving intermediate results in semi-structured format from a storage device; and
scanning the intermediate results to generate the results.
